(19) United States
(12) Patent Application Publication
(10) Pub. No.: US 2009/0128824 A1
(43) Pub. Date: May 21, 2009

(54) OPTICAL IMAGING SYSTEM WITH EXTENDED DEPTH OF FOCUS

(76) Inventors: Rainer Leitgeb, Ecublens (CH); Theo Lasser, Echandens (CH); Adrian Bachmann, Renens (CH); Lukas Steinmann, Luzern (CH); Martin Villiger, Ecublens (CH)

Correspondence Address: NIXON & VANDERHYE, PC, 901 NORTH GLEBE ROAD, 11TH FLOOR, ARLINGTON, VA, 22203, US

(21) Appl. No.: 12/162,088

(22) PCT Filed: Jan. 20, 2007
(86) PCT No.: PCT/IB2007/050195

§ 371 Date: Nov. 10, 2008

(30) Foreign Application Priority Data
Jan. 24, 2006 (IB) PCT/IB2006/050250

(51) Int. Cl. G01N 21/47

(52) U.S. Cl. 356/446

(57) ABSTRACT

The invention concerns an optical imaging apparatus comprising (o) a light source (1), (p) sample holding means, (q) an interferometer, (r) reference means, (s) an objective (8) which is adapted to have its sample side focal plane crossing a sample held in said sample holding means, (t) optical or electro-optical means (2, 3, 5, 16) adapted to produce a ring shaped or multi-spot light source in the front focal plane (17) or any conjugated plane (17′) of said objective (8), at least one detector. The invention also includes a method for using said apparatus where the sample is illuminated by an interference pattern and the depth information is obtained by using optical Coherence Tomography.

### FIELD OF INVENTION

The invention relates to optical imaging systems and more precisely to such systems and related methods using Optical Coherence Tomography (OCT).

### STATE OF THE ART

Several high-resolution systems are already existing in optical imaging, e.g. in microscopy.

Optical Coherence Tomography (OCT) is a high speed imaging technique that has been applied to measure full 3D tissue volumes in-vivo. In OCT the depth and transverse resolution are decoupled. The depth resolution is given by the coherence length of the employed light source, which in turn is proportional to the spectral width, while the transverse resolution is determined by the numerical aperture (A) of the objective. The detection in depth however has the drawback of losing transverse resolution along the optical axis especially if high numeric aperture objectives are used.

The axial resolution in OCT is given by the round trip coherence length and is defined as l_{c}=2 ln(2)λ₀²/πΔλ, where l_{c} is the coherence length, λ₀ the central wavelength and Δλ the FWHM of the spectrum of the light source, respectively. To obtain high axial resolution it is therefore necessary to work with a broadband illumination. In addition, for a Gaussian beam, the lateral resolution is defined by w₀=λ/πNA, where NA is the numerical aperture of the illumination optics. Complementary, the Rayleigh range of the Gaussian beam defines a depth range over which lateral resolution is retained, i.e., Δz_{max,Gauss}=2z₀=2πw₀²/λ, where w₀ is the waist of the Gaussian beam. Ideally, the two ranges match. A specific problem in applying high-resolution OCT to microscopy is the depth dependence of lateral resolution. The formulae for lateral resolution and focus depth are in contradiction: To obtain high lateral resolution, one would need a high NA but a high NA reduces by the power of two the maximal depth range (FIG. 1). For any point beyond the Rayleigh range, the divergence of the Gaussian beam is becoming important and lateral resolution degrades. Further, also due to the spread of the Gaussian beam, the signal intensity decreases by the power of two with the axial distance from the focus.

OCT as presently used is therefore not adapted for obtaining simultaneously high transverse and axial resolutions.

### GENERAL DESCRIPTION OF THE INVENTION

The principle idea to overcome the problems mentioned previously is to create a structured illumination in the sample. FIG. 2 shows a 2D section of the desired, rotationally symmetric (with respect to the optical axis) illumination geometry. This geometry is comparable to the known case of the interference between two plane waves with an open angle of 2α in between. Therefore, in analogy, the distance between the first zeros of the lateral circular interference pattern is expected to be of close to the value of Λ=λ/2 sin α. There are two important properties of such a configuration: Firstly, the lateral resolution, defined as half the size of the central interference lobe, remains constant over the distance D (FIG. 2). Secondly, the intensity of the central peak is expected to vary only slowly within the range of intersection. For the case of broadband illumination being used, one can suppress the side rings thanks to the limited temporal coherence. The optical path difference increases with lateral offset until it exceeds the coherence length of the used light. Therefore the lateral extension of the fringe visibility becomes close to |γ(τ)/2 sin α| (FIG. 3). Hence the broader the spectrum the better the suppression of the side rings. In the literature the term “diffraction-free” or “diffraction-less” beam is used referring to an illumination as described above [4]. The reason is that the intensity is concentrated within a narrow central lobe over a long axial distance without spreading. To obtain the described beam geometry and thus the desired interference pattern in the sample, two approaches have been followed by the inventors: An optical system containing a ring aperture in the focal plane of a lens and another system using a conical lens, i.e., a linear axicon. FIG. 4 shows the geometry for the ring aperture approach. This optical system consists of a circular ring aperture placed in the front focal plane of a positive thin lens. An incident monochromatic plane wave is diffracted at the ring aperture. It propagates through the thin lens creating the overlapping beam geometry and therefore the desired interference pattern in the sample side focal plane of the lens.

FIG. 5 shows the use of an axicon lens. The red and blue lines denote the area covered by the central lobes of the wave's intensity distribution between its first zeroes. Due to diffraction this area increases with distance from the aperture. The lens then offsets this effect, as indicated by the lines propagating in parallel behind the lens, though now on coalescing courses.

A preferred optical scheme is shown on FIG. 3. It is based on a Mach-Zehnder interferometer. Such a system allows decoupling the illumination from the detection with the possibility of employing a fast (single mirror) x-y scanner exactly in the center of the overlap region after the axicon.

Another possibility to produce an interference pattern is to use a prism instead of the axicon. This produces two spots in the focal plane of the microscope objective and finally a thin plane section through the sample. If each transverse point is now imaged onto an array detector one can simultaneously record all depth profiles at each transverse point.

Currently there are different realizations of OCT: time domain OCT, Fourier domain OCT (FOCT). Time domain OCT splits into standard methods where the carrier frequency for the interference signal is determined by a moving reference arm and the interference pattern is recorded as a function of path length difference between a reference arm and a sample arm. The other time-domain approach uses acousto-optic modulators to produce a fast carrier signal. The second method, Fourier domain OCT, splits into approaches where the source gives the full broad spectrum at the interferometer input, and other approaches where the source delivers only one frequency at a time but in both cases the spectral interferogram as a function of wave number or wavelength is recorded, and the depth structure is obtained via a Fourier transform of the spectrum.

FDOCT has nowadays largely replaced time domain OCT systems for in-vivo imaging of biological tissue. This is due to its inherent sensitivity advantage and the high achievable imaging speeds [1]. Recent ultrahigh resolution realizations of FDOCT presented retinal tomograms with axial resolutions below 3 μm [2,3,4].

The object of the invention relates therefore to an imaging apparatus which comprises
(a) a light source,
(b) sample holding means,
(c) an interferometer,
(d) reference means,
(e) an objective which is adapted to have its sample side focal plane crossing a sample held in said sample holding means,
(f) optical or electro-optical means adapted to produce a ring shaped or multi-spot light source in the front focal plane or any conjugated plane of said objective,
(g) at least one detector adapted to detect the resulting spectral interference pattern at the exit of the interferometer.

Preferred embodiments of the apparatus according to the invention are described in the apparatus dependent claims.

The invention also covers a sample imaging method using an apparatus as defined above wherein a sample is illuminated by an interference pattern and wherein the depth information is obtained by use of Optical Coherence Tomography.

Preferred embodiments of the method are described in the method dependent claims.

### SHORT DESCRIPTION OF THE FIGURES

FIG. 1: State-of-the-art: Dependence of transverse and axial resolution

FIG. 2: Generation of an interference pattern in a sample

FIG. 3: Cross-section through interference pattern

FIG. 4: Ring aperture illumination

FIG. 5: Linear axicon illumination

FIG. 6: Free-space interferometer set-up

FIG. 7: Fiber-coupled interferometer set-up

FIG. 8: Fiber-coupled scanning interferometer for 3D imaging

FIG. 9: Intensity distributions at the lens principal plane

FIG. 10: Intensity distribution and interference pattern at the lens

FIG. 11: Spectrometer entrance pupil

FIG. 12: Intensity distribution at the objective principal plane

FIG. 13: Focal field with a linear polarized laser beam

FIG. 14: Focal intensity with a linear polarized laser beam

FIG. 15: Focal field with a radial polarized laser beam

FIG. 16: Focal intensity with a radial polarized laser beam

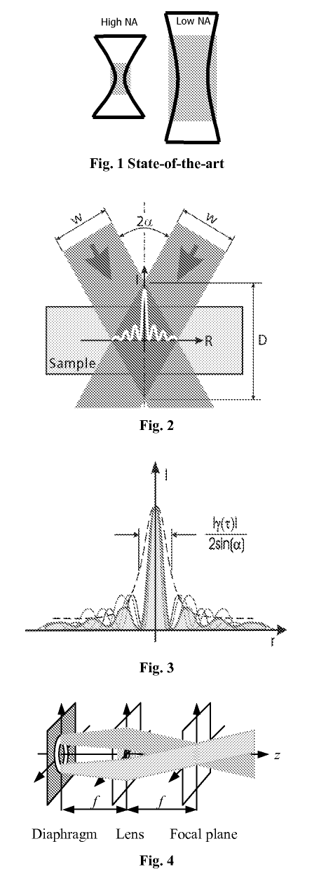

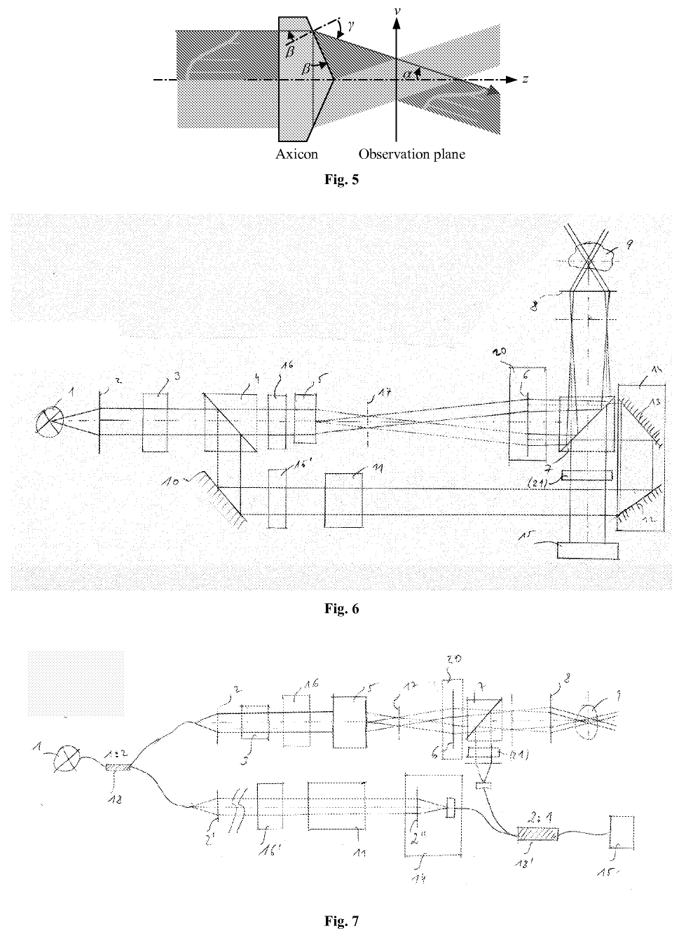

### DETAILED DESCRIPTION OF THE INVENTION

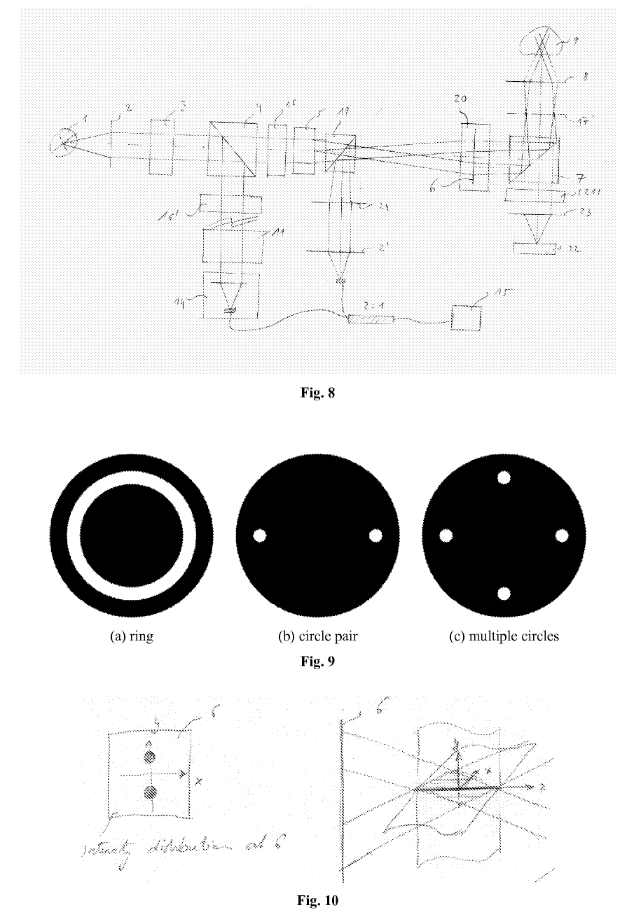

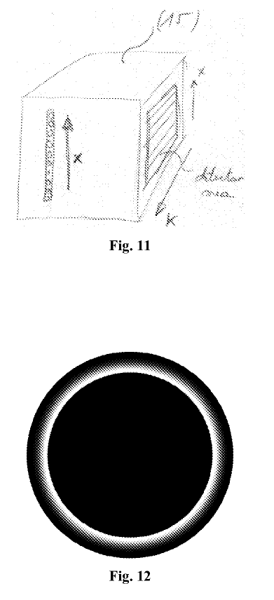

As it can be seen on the embodiment of FIG. 6, the apparatus comprises the following elements: (1) source; (2) collimator optics; (3) polarization control; (4) beam splitting means; (5) wavefront manipulator (e.g. axicon, prism, DMD, SLM, but limited to those); (6) lens; (7) beam splitting means; (8) objective; (9) sample; (10) reflector; (11) dispersion control; (12) and (13) reflector; (14) reference delay control (e.g. translation stage); (15) detector; (16) and (16′) phase modulation means or frequency shifting means; (17) focal plane with Bessel beam intensity pattern; (20) (instead of (6)) relay optics to access the conjugate plane to the front focal of the objective (8) and to position at this place e.g. a beam steering unit (see FIG. 8); (21) optional negative mask ideally designed to block the intensity distribution in the front focal plane of the objective for true dark field detection; can also be designed to block different parts of the light backscattered from the sample.

The embodiment of FIG. 7 contains the same numerical references as the ones shown on FIG. 6 together with new references (18) and (18′) which represent fiber couplers.

The same applies to the subsequent figures. The new elements represent: (19) beam splitting means; (20) beam steering unit; (21) dichroic beam splitting means; (22) detector.

FIG. 12 shows the incident light field of the laser beam at the principal plane of the 10×0.30 NA objective used in the calculations. The back-aperture of the objective had a diameter of 10 mm (outer limit) and was filled with the semi-Gauss ring; this means the focused axicon beam. The inner clear diameter was 8 mm and the Gauss-ring had a waist of 300 μm. After transmission through the objective, the field had a conical wavefront because the axicon beam was focused in the back-focal plane of the objective. This arrangement corresponds to a linear axicon with a NA of 0.25.

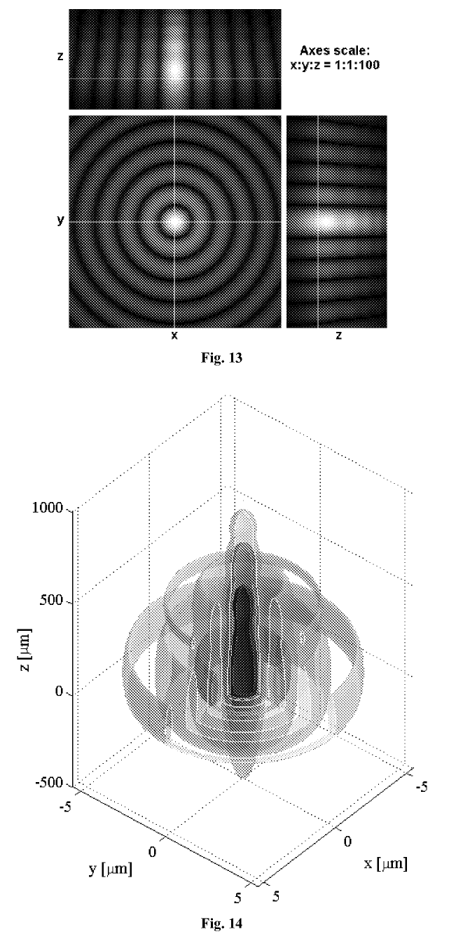

FIG. 13 represents cross-sections in the principal coordinate planes through the focal field, if a linear polarized laser beam (x-polarization) with a wavelength of 800 nm is used. At the focus, the optical medium had an index of refraction of 1.33 (water). The field was calculated in a region of 16 μm×16 μm×1500 μm. The z-axis was compressed 100× compared to the x- and y-axis. The central lobe has a diameter of ≈2 μm but extends over ≈1 mm in depth!

FIG. 14 is a three-dimensional intensity distribution for the situation described in FIG. 13. The red, orange and yellow surfaces show the iso-intensity surfaces at e⁻¹, e⁻² and e⁻³ of the maximum intensity.

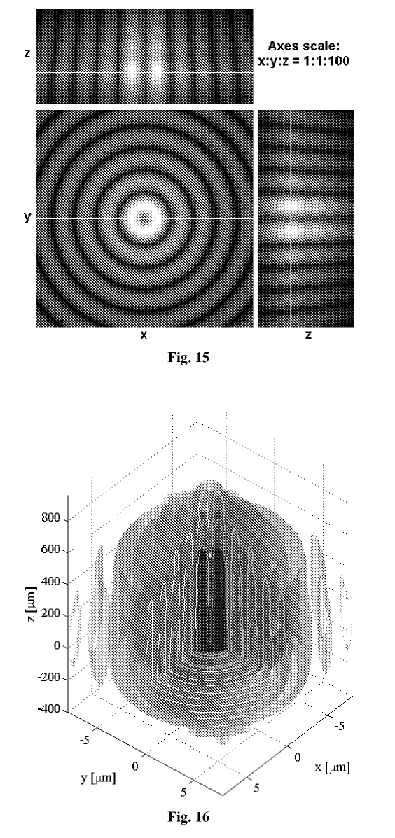

FIG. 15 represent cross-sections in the principal coordinate planes through the focal field, if a radial polarized laser beam with a wavelength of 800 nm is used. At the focus, the optical medium had an index of refraction of 1.33 (water). The field was calculated in a region of 16 μm×16 μm×1400 μm. The z-axis was compressed 100× compared to the x- and y-axis. On the z-axis, the field is weak and the maximum is found in the first ring instead. The central ring has an inner diameter of ≈2 μm and an outer diameter of ≈4 μm, respectively. As with the linear polarized laser beam, the focal field extends over ≈1 mm in depth!

FIG. 16 is a three-dimensional intensity distribution for the situation described in FIG. 15. The red, orange and yellow surfaces show the iso-intensity surfaces at e⁻¹, e⁻² and e⁻³ of the maximum intensity.

The apparatus according to the invention may comprise the following elements

Interferometer:
1) With at least one reference arm and a sample arm or
2) only one sample arm where a prominent sample reflection serves as reference;

References
1) reflector in at least one arm of the interferometer
2) at least one prominent reflection in the sample arm

Detector:

The detector can in general be an array or a single point detector, depending on the application. The array detector may be based on CCD or CMOS technology but not limited to those. In case of a CMOS detector the demodulation can be performed already on chip such as for SPDA detectors.

Steering unit:

The steering unit is placed in an appropriate conjugated plane to the front focal plane of the objective in front of the sample and controls the lateral position of the intensity distribution at the sample. It can be realized by moving refractive optical elements (prisms, etc), by moving reflective elements, or combined moving reflective and refractive elements, or by spatial phase modulators (LCD, DMD technology, or similar), but not limited to those specific elements. The steering unit contains in addition control elements to synchronize the detection with the lateral position of the intensity distribution at the sample.

Light Source:

The source is in general a broadband light source that exhibits temporally partial coherence. It can also be a synthetic source consisting of a multitude of combined monochromatic sources as well as a source consisting of a multitude of combined broad bandwidth sources. The source can also deliver only one frequency at a given time sweeping through its entire spectrum.

Frequency Shifting Means:

A frequency-shifting mean changes the optical frequency of the incoming wave. It can be realized via acousto-optical (AO) elements or moving diffracting elements such as gratings, but not limited to those.

Phase Modulating Means:

A phase modulating mean in an interferometer manipulates the phase of the reference or the sample wave by changing their optical path length. This can be achieved either by changing the geometric path length (e.g. piezo-electric arm length modulation) or by changing the refractive index of the modulator substrate (e.g. electro-optic modulator).

Of course the invention is not limited to the above cited examples.

### REFERENCES

1. R. A. Leitgeb, C. K. Hitzenberger, A. F. Fercher, Opt. Express 11: 889-894 (2003)
2. R. A. Leitgeb, W. Drexler, A. Unterhuber, et al., Opt. Express 12: 2156-2165 (2004)
3. M. Wojtkowski, V. J. Srinivasan, T. H. Ko, J. G. Fujimoto, A. Kowalczyk, J. S. Duker, Opt. Express 12: 2404-2422 (2004)
4. R. M. Herman, T. A. Wiggins, J. Opt. Soc. Am. A 8: 932-942 (1990)

1. An imaging apparatus comprising
(a) a light source,
(b) sample holding means,
(c) an interferometer,
(d) reference means,
(e) an objective which is adapted to have its sample side focal plane crossing a sample held in said sample holding means,
(f) optical or electro-optical means adapted to produce a ring shaped or multi-spot light source in the front focal plane or any conjugated plane of said objective,
(g) at least one detector adapted to detect the resulting spectral interference pattern at the exit of the interferometer.

2. An imaging apparatus according to claim 1 furthermore comprising a steering unit adapted to generate a lateral displacement of the intensity distribution in the sample side focal plane of the objective, said steering unit being placed in an appropriate conjugated plane of said objective.

3. An imaging apparatus according to claim 1 wherein said light source is adapted to illuminate said interferometer with a single light frequency at a time.

4. An imaging apparatus according to claim 3 wherein said detector is adapted to detect the spectral interference pattern as a function of time.

5. An imaging apparatus according to claim 1 comprising phase modulating means.

6. An imaging apparatus according to claim 5 wherein said phase modulating means are adapted for changing the optical path length of the reference wave or the sample wave.

7. An imaging apparatus according to claim 6 wherein said means for changing the optical path length are adapted to change the geometric path length.

8. An imaging apparatus according to claim 6 wherein said means for changing the optical path length are adapted to change the refractive index of a modulator substrate.

9. An imaging apparatus according to claim 1 comprising frequency shifting means which are adapted to change the optical frequency of the incoming wave.

10. An imaging apparatus according to claim 6 wherein said detector is adapted to detect the spectral interference pattern as a function of optical path length difference between the sample signal and the reference signal.

11. An imaging apparatus according to claim 1 wherein said interferometer comprises one sample arm and one reference arm.

12. An imaging apparatus according to claim 1 wherein said reference means consist of a prominent sample reflection.

13. An imaging apparatus according to claim 10 comprising a sample arm and wherein said prominent sample reflection is in said sample arm.

14. Sample imaging method using an apparatus according to claim 1 wherein a sample is illuminated by an interference pattern and wherein the depth information is obtained by use of Optical Coherence Tomography.

15. Sample imaging method according to claim 14 using at least one frequency shifting means in at least one interferometer arm wherein said frequency shifting means generate a signal carrier frequency.

16. Sample imaging method according to claim 14 using at least one phase modulating means in at least one interferometer arm wherein said phase modulating means generate a signal carrier frequency.

17. Sample imaging method according to claim 14, providing spectral interference patterns corresponding to distinct transverse points on a sample, wherein said transverse points are recorded separately and synchronously on an array detector.
